(19) United States
(12) Patent Application Publication
(10) Pub. No.: US 2019/0061313 A1
(43) Pub. Date: Feb. 28, 2019

(54) FOAM CONSTRUCTION BOARDS WITH EXPANDABLE GRAPHITE

(71) Applicant: Firestone Building Products Company, LLC, Nashville, TN (US)

(72) Inventors: Chunhua Yao, Carmel, IN (US); John Letts, Carmel, IN (US); Wensheng Zhou, Carmel, IN (US)

(21) Appl. No.: 15/772,335

(22) PCT Filed: Nov. 9, 2016
(86) PCT No.: PCT/US16/61072

§ 371 Date: Apr. 30, 2018

Related U.S. Application Data
(60) Provisional application No. 62/252,640, filed on Nov. 9, 2015.

(51) Int. Cl. B32B 5/24; B32B 5/02; B32B 5/18; B32B 25/10; B32B 27/12; B32B 27/32; B32B 27/30; E04C 2/296; E04B 1/80; E04B 1/94

(52) U.S. Cl. CPC B32B 5/245; B32B 2262/067; B32B 5/18; B32B 25/10; B32B 27/12; B32B 27/32; B32B 27/304; E04C 2/296; E04B 1/80; E04B 1/942; B32B 2250/40; B32B 2255/02; B32B 2255/24; B32B 2255/26; B32B 2262/101; B32B 2264/108; B32B 2266/0278; B32B 2266/08; B32B 2307/304; B32B 2307/3065; B32B 2307/7265; B32B 2419/06; B32B 2607/00; B32B 2262/062; B32B 5/022

(57) ABSTRACT

A construction board comprising a foam layer; and at least one facer, wherein the at least one facer includes a substrate and a coating, wherein said facer includes a first planar surface and a second planar surface, and where said first planar surface is in contact with said foam layer and where said coating is disposed on said second planar surface, where the coating includes expandable graphite.

This application claims the benefit of U.S. Provisional Application Ser. No. 62/252,640, filed on Nov. 9, 2015, which is incorporated herein by reference.

### FIELD OF THE INVENTION

Embodiments of the present invention are directed toward foam construction boards that include expandable graphite.

### BACKGROUND OF THE INVENTION

Construction boards, particularly those employed in the construction industry, may include a foam layer and at least one facer. Often, the foam layer is sandwiched between two facers. The foam layer can include a closed cell polyurethane or polyisocyanurate foam.

The facer materials can impact the ultimate performance of the construction boards. This is particularly true where the construction boards include roofing insulation boards or roofing recover boards that must meet various performance specifications.

Numerous facer materials have been employed; for example, the art teaches cellulosic, foil, and fiberglass facers. Many facers commercially employed in roofing construction boards today include various recycled cellulosic materials. Inasmuch as the quality of these cellulosic materials may be suspect, conventional practice includes combining the cellulosic material with fiberglass in an effort to improve the performance of the facer with construction boards.

### SUMMARY OF THE INVENTION

Embodiments of the present invention provide a construction board comprising a foam layer; and at least one facer, wherein the at least one facer includes a substrate and a coating, wherein said facer includes a first planar surface and a second planar surface, and where said first planar surface is in contact with said foam layer and where said coating is disposed on said second planar surface, where the coating includes expandable graphite.

### BRIEF DESCRIPTION OF THE DRAWINGS

FIG. 1 is a perspective view of a construction board of one or more embodiments of the present invention.

FIG. 2 is a fragmentary side profile view of a construction board of one or more embodiments of the present invention, and shows a coated facer having a barrier coating.

FIG. 3 is a perspective view of a roofing system including one or more construction boards according to practice of one or more embodiments of the present invention.

### DETAILED DESCRIPTION OF ILLUSTRATIVE EMBODIMENTS

Embodiments of the present invention are based, at least in part, on the discovery of a construction board having improved properties based upon the inclusion of expandable graphite in the construction board. In one or more embodiments, the expandable graphite is disposed on a facer of the construction board. In other embodiments, the expandable graphite is included within the matrix of the foam core of the construction boards. In yet other embodiments, the expandable graphite is both disposed on a facer and included in the matrix of the foam core. In particular embodiments, the expandable graphite is present in combination with a non-halogenated flame retardant. As a result of this combination, construction boards with improved properties, such as improved fire resistance, are provided.

### Construction Board Configuration

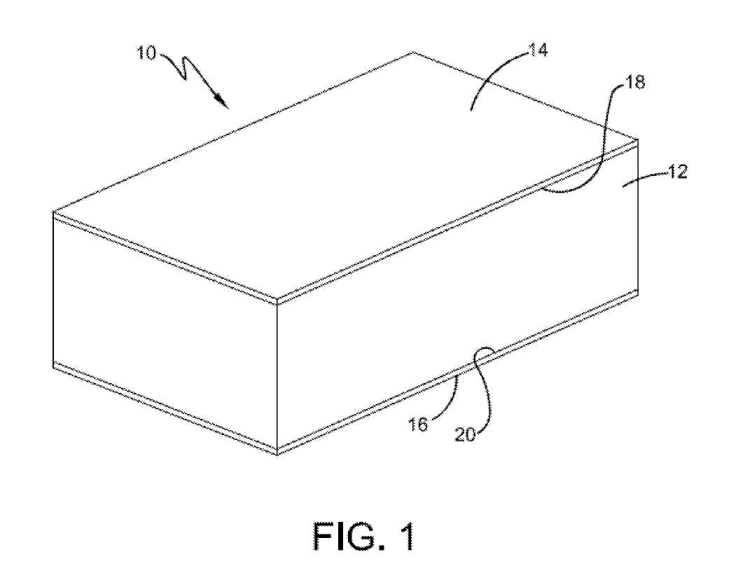

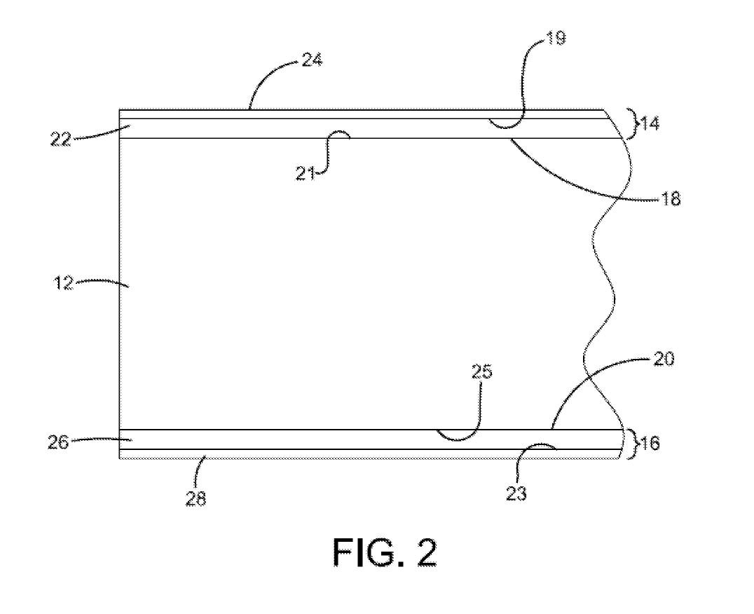

Construction boards of one or more embodiments of the present invention may be described with reference to FIGS. 1 and 2. FIG. 1 shows a construction board that is indicated generally by the numeral 10. Construction board 10 includes a foam layer 12, which may be referred to as foam core 12, sandwiched between first facer 14 and optional second facer 16. Facers 14 and 16 are attached to foam layer 12 at first planar surface 18 and second planar surface 20, respectively, of foam layer 12. In one or more embodiments, facer 14 (and optionally facer 16) are continuous over the entire planar surface 18 (or planar surface 20) of foam core 12. In these or other embodiments, facer 14 (and optionally facer 16) are discontinuous; for example, the facers may be perforated so as to allow fluid or gaseous communication between the foam and the environment.

### Foam Core

In one or more embodiments, foam layer 12 includes a rigid closed-cell foam structure. In one or more embodiments, foam layer 12 may include a polyurethane or polyisocyanurate foam. As the skilled person appreciates, the closed-cell foam includes a plurality of cells and an interconnected network of solid struts or plates that form the edges and faces of the cells. The solid portion (i.e., the interconnected network) is formed from the foam-forming material (e.g., the polyurethane or polyisocyanurate). The solid portion of foam layer 12 (i.e., the matrix) may include other constituents as is generally known in the art. As will be discussed in greater detail below, the expandable graphite can be dispersed within the solid portion of foam layer 12. Additionally, in one or more embodiments, the expandable graphite is dispersed within the solid portion of foam layer 12 in combination with a non-halogenated flame retardant.

In one or more embodiments, foam layer 12 may be characterized by a foam density (ASTM C303) that is less than 2.5 pounds per cubic foot (12 kg/m2), in other embodiments less than 2.0 pounds per cubic foot (9.8 kg/m2), in other embodiments less than 1.9 pounds per cubic foot (9.3 kg/m2), and still in other embodiments less than 1.8 pounds per cubic foot (8.8 kg/m2). In one or more embodiments, the foam layer 12 of insulation boards is characterized by having a density that is greater than 1.50 pounds per cubic foot (7.32 kg/m2), or in other embodiments, greater than 1.55 pounds per cubic foot (7.57 kg/m2).

Where the density of foam layer 12 is less than 2.5 pounds per cubic foot, it may be advantageous for foam layer 12 to be characterized by having an index of at least 120, in other embodiments at least 150, in other embodiments at least 175, in other embodiments at least 200, and in other embodiments at least 225, as determined by PIR/PUR ratio as determined by IR spectroscopy using standard foams of known index (note that ratio of 3 PIR/PUR provides an ISO Index of 300). Foam construction boards having a foam layer of similar nature are described in U.S. Pat. Nos. 6,117,375, 6,044,604, 5,891,563, 5,573,092, U.S. Publication Nos. 2004/01099832003/0082365, 2003/0153656, 2003/0032351, and 2002/0013379, as well as U.S. Ser. Nos. 10/640,895, 10/925,654, and 10/632,343, which are incorporated herein by reference.

In other embodiments, foam layer 12 may be characterized by density that is greater than 2.5 pounds per cubic foot (12.2 kg/m2), as determined according to ASTM C303, in other embodiments the density is greater than 2.8 pounds per cubic foot (13.7 kg/m2), in other embodiments greater than 3.0 pounds per cubic foot (14.6 kg/m2), and still in other embodiments greater than 3.5 pounds per cubic foot (17.1 kg/m2). In one or more embodiments, the density of foam layer 12 of the recovery boards may be less than 20 pounds per cubic foot (97.6 kg/m2), in other embodiments less than 10 pounds per cubic foot (48.8 kg/m2), in other embodiments less than 6 pounds per cubic foot (29.3 kg/m2), in other embodiments less than 5.9 pounds per cubic foot (28.8 kg/m2), in other embodiments less than 5.8 pounds per cubic foot (28.3 kg/m2), in other embodiments less than 5.7 pounds per cubic foot (27.8 kg/m2), in other embodiments less than 5.6 pounds per cubic foot (27.3 kg/m2), and still in other embodiments less than 5.5 pounds per cubic foot (26.9 kg/m2). Foam construction boards having a foam layer of similar nature are described in U.S. application Ser. Nos. 11/343,466 and 12/525,159, which are incorporated herein by reference.

Where the density of foam layer 12 is greater than 2.5 pounds per cubic foot, it may be advantageous for foam layer 12 to be characterized by an ISO Index, as determined by PIR/PUR ratio as determined by IR spectroscopy using standard foams of known index (note that ratio of 3 PIR/PUR provides an ISO Index of 300) of at least 180, in other embodiments at least 200, in other embodiments at least 220, in other embodiments at least 270, in other embodiments at least 285, in other embodiments at least 300, in other embodiments at least 315, and in other embodiments at least 325. In these or other embodiments, the ISO Index may be less than 360, in other embodiments less than 350, in other embodiments less than 340, and in other embodiments less than 335.

### Facers

As shown in FIG. 2, first facer 14 of one or more embodiments includes a coating layer 24 disposed on a substrate 22. Coating 24 is situated on a first planar surface 19 of substrate 22, which is opposite foam layer 12 and opposite second planar surface 21 of substrate 22 (or the second surface 21 of facer 14), which second planar surface 21 is adjacent planar surface 18 of foam core 12. In a similar fashion, second facer 16 can also include a coating 28 disposed on a substrate 26. Coating 28 is likewise situated on a first planar surface 23 of substrate 26, which coating is opposite foam layer 12 and opposite second planar surface 25 of substrate 26 (or second planar surface 25 of facer 16), which second planar surface 25 is adjacent second planar surface 20 of foam core 12. In one or more embodiments, the foam construction boards of this invention include opposed coated facers 14 and 16.

### Inorganic Substrate

In one or more embodiments, substrate 22, as well as substrate 26, is an inorganic substrate. In particular embodiments, the substrate is a non-woven inorganic mat, and therefore reference may be made to glass substrate 22 (or 26). Exemplary types of non-woven mat include fiberglass mats, which may also be referred to as glass mats. In one or more embodiments, the non-woven fiberglass mats include glass fibers and a binder that binds the glass fibers together and maintains the fibers in a mat form. Any type of glass fiber mat can be used in the composite board. For example, a non-woven glass fiber mat can be made with glass fibers, the fibers can be bonded with an aqueous thermosetting resin such as, for example, urea formaldehyde or phenolic resole resins. As the skilled person will appreciate, these binder resins are conventional in the art of non-woven glass mats, and the skilled person will understand that the coating, as taught herein, is distinct, in both composition and structure, from this binder.

In one or more embodiments, the dimensional and weight characteristics of glass substrate 22 (or 26) are not particularly limited, and can depend on the specific application and desired properties of the coverboard. For example, the basis weight of glass substrate 22 (or 26) can be from about 50 grams per square meter to about 150 grams per square meter. The thickness of glass substrate 22 (or 26) can be, for example, from about 0.015 inch to about 0.05 inch (about 0.038 to about 0.13 cm). The basis weight and thickness characteristics can be adjusted depending upon the desired rigidity, strength and weight of the composite board.

In one or more embodiments, the thickness of glass substrate 22 (or 26) (absent the coating layer described herein) may be from about 0.01 to about 1.00 inch (about 0.03 to about 2.54 cm) or in other embodiments from about 0.015 to about 0.05 inches thick (about 0.038 to about 0.13 cm).

### Cellulosic Substrate

In other embodiments, substrate 22, as well as substrate 26, includes cellulose fibers, which may also be referred to as pulp, and therefore reference can be made to cellulosic substrate 22. In one or more embodiments, the cellulose fibers may derive from wood, fiber crops, or waste paper. Wood fibers, also referred to as pulpwood, may derive from softwood trees such as spruce, pine, fir, larch, and hemlock, or from hardwoods such as eucalyptus, aspen and birch. As is known in the art, pulp can be obtained by mechanical, chemical, thermo-mechanical, or recycle pulping processes. In particular embodiments, the pulp is obtained from kraft processing. In these or other embodiments, the pulp is de-inkend or recycled pulp. In particular embodiments, the pulp may be bleached. In other embodiments, the pulp is un-bleached.

In one or more embodiments, cellulosic substrate 22, as well as substrate 26, (apart from any coating that may be applied thereto) may be characterized by a density of at least 400 kg/m3, in other embodiments at least, 500 kg/m3, in other embodiments at least 750 kg/m3, in other embodiments at least 1000 kg/m3, in other embodiments at least 1250 kg/m3, and in other embodiments at least 1500 kg/m3.

In one or more embodiments, cellulosic substrate 22, as well as substrate 26, (apart from any coating that may be applied thereto) may be characterized by a thickness of at least 5 mils (0.12 mm), in other embodiments at least 7 mils (0.17 mm), and in other embodiments at least 10 mils (0.25 mm). In these or other embodiments, the cellulose fiber substrate 22 of the at least one facer has a thickness of at most 40 mils, in other embodiments at most 35 mils, in other embodiments at most 30 mils (0.5 mm), and in other embodiments at most 27 mils (0.45 mm). In one or more embodiments, the thickness may be from about 5 to about 40, in other embodiments from about 7 to about 35, and in other embodiments form about 15 to about 30 mils.

In one or more embodiments, cellulosic substrate 22, as well as substrate 26, may have a basis weight of at least 25, in other embodiments at least 35, in other embodiments at least 45, in other embodiments at least 55, and in other embodiments at least 65 pounds per 1000 square feet. In these or other embodiments, the basis weight of cellulosic substrate 22 is essentially consistent across the planar surface of the construction board.

In one or more embodiments, the cellulosic substrate 22, as well as substrate 26, is free of or only includes limited amounts of non-cellulosic materials (e.g., fiberglass). For example, in certain embodiments, cellulosic substrate 22 includes less than 15% by weight, in other embodiments less than 10% by weight, in other embodiments less than 5% by weight, and in other embodiments less than 1% by weight fiberglass based on the entire weight of cellulosic substrate 22. In particular embodiments, the cellulosic substrate 22 is substantially devoid of fiberglass, which includes an amount less than would otherwise have an appreciable impact on the facer and/or construction board. In one or more embodiments, the at least one cellulosic substrate 22 of the construction boards is devoid of fiberglass.

In other embodiments, cellulosic substrate 22, as well as substrate 26, includes glass reinforcement. For example, cellulosic substrate 22 may include a plurality of glass stands or fibers that are positioned in a parallel fashion and extend in the machine-direction of the mat.

### Facer Coating

In one or more embodiments, coating 24 (as well as coating 28) includes a binder or matrix and optionally filler or other constituents dispersed throughout the binder. As will be discussed in greater detail below, the expandable graphite is likewise dispersed throughout the binder. Additionally, in one or more embodiments, the expandable graphite is dispersed within the binder in combination with a non-halogenated flame retardant.

In one or more embodiments, the binder may include natural or synthetic materials. For example, natural materials may include natural rubber, waxes and starches. Synthetic materials may include polyolefins, styrene-butadiene latexes, polyvinyl chlorides, acrylic latexes, and methacrylic latexes, silicones, as well as functional copolymers thereof. For example, the binders may include styrene-butadiene latexes bearing one or more hydrophobic moieties (e.g., fluorine-containing groups) for repelling water. Still other examples include, but not limited to, polyurethane coating compositions, polymeric resin coating compositions, and siloxane coating compositions, as well as polymer-modified asphalt or bitumen coating compositions.

In one or more embodiments, coating 24 (as well as coating 28) is applied to cellulosic substrate 22 by applying a liquid coating composition by employing conventional paper coating techniques. For example, coating 24 may be applied by gravure coating, reverse roll coating, slot die coating, immersion (dip) coating, knife coating, electrohydrodynamic spraying, and the like. In one or more embodiments, these liquid coating compositions may include at least 0.5 wt. %, in other embodiments at least 1.0 wt. %, in other embodiments at least 3 wt. %, in other embodiments at least 5 wt. %, and in other embodiments at least 7 wt. % expandable graphite, based on the entire weight of the liquid composition. In these or other embodiments, these coating compositions include at most 40 wt. %, in other embodiments at most 30 wt. %, in other embodiments at most 25 wt. %, in other embodiments at most 20 wt. %, and in other embodiments at most 15 wt. % expandable graphite, based on the entire weight of the liquid composition. In one or more embodiments, these compositions include from about 0.5 to about 40, in other embodiments from about 1 to about 25, and in other embodiments from about 2 to about 20 wt. % expandable graphite, based upon the entire weight of the liquid composition.

In one or more embodiments, coating 24 (as well as coating 28) may have a thickness of at least 0.005 mm, in other embodiments at least 0.01 mm, in other embodiments 0.05 mm, and in other embodiments at least 0.09 mm. In these or other embodiments, coating 24 may have a thickness of less than 1.5 mm, in other embodiments less than 1.0 mm, in other embodiments less than 0.7 mm, in other embodiments less than 0.3 mm, and in other embodiments less than 0.1 mm.

In one more embodiments, coating 24 (as well as coating 28) is applied over the entire planar surface 19 of substrate 22 (or over the entire planar surface 23 of substrate 26). In other embodiments, coatings 24 and/or 28 are applied over only a portion of planar surfaces 19 and 23. In particular embodiments, coating 24 and/or 28 is applied in a crisscross pattern.

### Expandable Graphite

In one or more embodiments, expandable graphite, which may also be referred to as expandable flake graphite, intumescent flake graphite, or expandable flake, includes intercalated graphite in which an intercallant material is included between the graphite layers of graphite crystal or particle. Examples of intercallant materials include halogens, alkali metals, sulfates, nitrates, various organic acids, aluminum chlorides, ferric chlorides, other metal halides, arsenic sulfides, and thallium sulfides. In certain embodiments of the present invention, the expandable graphite includes non-halogenated intercallant materials. In certain embodiments, the expandable graphite includes sulfate intercallants, also referred to as graphite bisulfate. As is known in the art, bisulfate intercalation is achieved by treating highly crystalline natural flake graphite with a mixture of sulfuric acid and other oxidizing agents which act to catalyze the sulfate intercalation.

Commercially available examples of expandable graphite include HPMS Expandable Graphite (HP Materials Solutions, Inc., Woodland Hills, Calif.) and Expandable Graphite Grades 1721 (Asbury Carbons, Asbury, N.J.). Other commercial grades contemplated as useful in the present invention include 1722, 3393, 3577, 3626, and 1722HT (Asbury Carbons, Asbury, N.J.).

In one or more embodiments, the expandable graphite may be characterized as having a mean or average size in the range from about 30 μm to about 1.5 mm, in other embodiments from about 50 μm to about 1.0 mm, and in other embodiments from about 180 to about 850 μm. In certain embodiments, the expandable graphite may be characterized as having a mean or average size of at least 30 μm, in other embodiments at least 44 μm, in other embodiments at least 180 μm, and in other embodiments at least 300 μm. In one or more embodiments, expandable graphite may be characterized as having a mean or average size of at most 1.5 mm, in other embodiments at most 1.0 mm, in other embodiments at most 850 μm, in other embodiments at most 600 μm, in yet other embodiments at most 500 μm, and in still other embodiments at most 400 μm. Useful expandable graphite includes Graphite Grade #1721 (Asbury Carbons), which has a nominal size of greater than 300 μm.

In one or more embodiments, the expandable graphite may be characterized as having a nominal particle size of 20×50 (US sieve). US sieve 20 has an opening equivalent to 0.841 mm and US sieve 50 has an opening equivalent to 0.297 mm. Therefore, a nominal particle size of 20×50 indicates the graphite particles are at least 0.297 mm and at most 0.841 mm.

In one or more embodiments, the expandable graphite may be characterized as having a carbon content in the range from about 75% to about 99%. In certain embodiments, the expandable graphite may be characterized as having a carbon content of at least 80%, in other embodiments at least 85%, in other embodiments at least 90%, in yet other embodiments at least 95%, in other embodiments at least 98%, and in still other embodiments at least 99% carbon.

In one or more embodiments, the expandable graphite may be characterized as having a sulfur content in the range from about 0% to about 8%, in other embodiments from about 2.6% to about 5.0%, and in other embodiments from about 3.0% to about 3.5%. In certain embodiments, the expandable graphite may be characterized as having a sulfur content of at least 0%, in other embodiments at least 2.6%, in other embodiments at least 2.9%, in other embodiments at least 3.2%, and in other embodiments 3.5%. In certain embodiments, the expandable graphite may be characterized as having a sulfur content of at most 8%, in other embodiments at most 5%, in other embodiments at most 3.5%.

In one or more embodiments, the expandable graphite may be characterized as having an expansion ratio (cc/g) in the range from about 10:1 to about 500:1, in other embodiments at least 20:1 to about 450:1, in other embodiments at least 30:1 to about 400:1, in other embodiments from about 50:1 to about 350:1. In certain embodiments, the expandable graphite may be characterized as having an expansion ratio (cc/g) of at least 10:1, in other embodiments at least 20:1, in other embodiments at least 30:1, in other embodiments at least 40:1, in other embodiments at least 50:1, in other embodiments at least 60:1, in other embodiments at least 90:1, in other embodiments at least 160:1, in other embodiments at least 210:1, in other embodiments at least 220:1, in other embodiments at least 230:1, in other embodiments at least 270:1, in other embodiments at least 290:1, and in yet other embodiments at least 300:1. In certain embodiments, the expandable graphite may be characterized as having an expansion ratio (cc/g) of at most 350:1, and in yet other embodiments at most 300:1.

In one or more embodiments, the expandable graphite may be characterized as having a pH in the range from about 1 to about 12; in other embodiments from about 1 to about 6; and in yet other embodiments from about 5 to about 10. In certain embodiments, the expandable graphite may be characterized as having a pH in the range from about 4 to about 7. In one or more embodiments, the expandable graphite may be characterized as having a pH of at least 1, in other embodiments at least 4, and in other embodiments at least 5. In certain embodiments, the expandable graphite may be characterized as having a pH of at most 10, in other embodiments at most 7, and in other embodiments at most 6.

In one or more embodiments, the expandable graphite may be characterized by an onset temperature ranging from about 100° C. to about 250° C.; in other embodiments from about 160° C. to about 225° C.; and in other embodiments from about 180° C. to about 200° C. In one or more embodiments, the expandable graphite may be characterized by an onset temperature of at least 100° C., in other embodiments at least 130° C., in other embodiments at least 160° C., and in other embodiments at least 180° C. In one or more embodiments, the expandable graphite may be characterized by an onset temperature of at most 250° C., in other embodiments at most 225° C., and in other embodiments at most 200° C. Onset temperature may also be interchangeably referred to as expansion temperature; and may also be referred to as the temperature at which expansion of the graphite starts.

### Expandable Graphite Amounts

As suggested above, in one or more embodiments, the solid portion of foam layer 12 (i.e. the matrix) may include expandable graphite dispersed therein.

Where the expandable graphite is present in the solid portion of foam layer 12, the amount of expandable graphite included within foam layer 12 may represented based upon the percent of the density of the foam occupied by the expandable graphite. In one or more embodiments, at least 2%, in other embodiments at least 5%, in other embodiments at least 10%, in other embodiments at least 15%, in other embodiments at least 20%, in other embodiments at least 25%, in other embodiments at least 30% of the density of the foam is expandable graphite. In these or other embodiments, at most 50%, in other embodiments at most 45%, in other embodiments at most 35%, in other embodiments at most 30%, in other embodiments at most 25%, in other embodiments at most 20%, in other embodiments at most 15% of the density of the foam is expandable graphite. In one or more embodiments, foam layer 12 includes from about 2% to about 50%, in other embodiments from about 5 to about 40%, and in other embodiments from about 10 to about 30% of the density of the foam is expandable graphite.

As suggested above, in one or more embodiments, coating layer 24 and/or 28 may include expandable graphite dispersed therein.

In one or more embodiments, where expandable graphite is present in the coating layer, the amount of expandable graphite with the coating may be defined as a weight percentage relative to the weight of the dried coating. In one or more embodiments, at least 2%, in other embodiments at least 5%, in other embodiments at least 10%, in other embodiments at least 15%, in other embodiments at least 20%, in other embodiments at least 25%, in other embodiments at least 30% by weight of the dried coating is expandable graphite. In these or other embodiments, at most 50%, in other embodiments at most 45%, in other embodiments at most 35%, in other embodiments at most 30%, in other embodiments at most 25%, in other embodiments at most 20%, in other embodiments at most 15% by weight of the dried coating is expandable graphite. In one or more embodiments, either coating 24 or 28 include from about 2% to about 50%, in other embodiments from about 5 to about 40%, and in other embodiments from about 10 to about 30% by weight of the dried coating is expandable graphite.

### Non-Halogenated Flame Retardants

As suggested above, the solid portion of foam layer 12 and/or the coating layer 24 and/or 28 may include a non-halogenated flame retardant. In one or more embodiments, non-halogenated flame retardants may include those non-halogenated compounds that increase the burn resistivity, particularly flame spread such as tested by UL 94 and/or UL 790, in the polymeric compositions of the present invention. In one or more embodiments, useful non-halogenated flame retardants include those that operate by forming a char-layer across the surface of a specimen when exposed to a flame.

Useful non-halogenated flame retardants include solid flame retardants or in other embodiments liquid flame retardants. In one or more embodiments, the non-halogenated flame retardants may be reactive flame retardants (i.e. they have a isocyanate-reactive group, such as a hydroxyl group), which are those flame retardants that do not react with the isocyanate, and in other embodiments may include non-reactive flame retardants, which are those flame retardants that do not react with the isocyanate.

Exemplary non-halogenated solid flame retardants include magnesium hydroxide, aluminum trihydrate, zinc borate, ammonium polyphosphate, melamine polyphosphate, and antimony oxide (Sb₂O₃). Magnesium hydroxide (Mg(OH)₂) is commercially available under the tradename Vertex™ 60, ammonium polyphosphate is commercially available under the tradename Exolite™ AP 760 (Clarian), melamine polyphosphate is available under the tradename Budit™ 3141 (Budenheim), and antimony oxide (Sb₂O₃) is commercially available under the tradename Fireshield™. Exemplary non-halogenated liquid flame retardants include triethylphosphate, such as that available under the tradename TEP (Lanxess). Exemplary reactive flame retardants include liquid reactive phosphates such as those available under the tradenames E06-16 (ICL) FYROL (ICL).

### Non-Halogenated Flame Retardant Amounts

As suggested above, the solid portion of foam layer 12 (i.e. the matrix) may include non-halogenated flame retardant dispersed therein together with expandable graphite.

Where the non-halogenated flame retardant is present in the solid portion of foam layer 12, the amount of non-halogenated flame retardant included within foam layer 12 may represented based upon the percent of the density of the foam occupied by the non-halogenated flame retardant. In one or more embodiments, at least 2%, in other embodiments at least 5%, in other embodiments at least 10%, in other embodiments at least 15%, in other embodiments at least 20%, in other embodiments at least 25%, in other embodiments at least 30% of the density of the foam is non-halogenated flame retardant. In these or other embodiments, at most 50%, in other embodiments at most 45%, in other embodiments at most 35%, in other embodiments at most 30%, in other embodiments at most 25%, in other embodiments at most 20%, in other embodiments at most 15% of the density of the foam is non-halogenated flame retardant. In one or more embodiments, foam layer 12 includes from about 2% to about 50%, in other embodiments from about 5 to about 40%, and in other embodiments from about 10 to about 30% of the density of the foam is non-halogenated flame retardant.

As suggested above, coating layer 24 and/or 28 may include non-halogenated flame retardant dispersed therein together with expandable graphite.

In one or more embodiments, where non-halogenated flame retardant is present in the coating layer, the amount of non-halogenated flame retardant with the coating may be defined as a weight percentage relative to the weight of the dried coating. In one or more embodiments, at least 2%, in other embodiments at least 5%, in other embodiments at least 10%, in other embodiments at least 15%, in other embodiments at least 20%, in other embodiments at least 25%, in other embodiments at least 30% by weight of the dried coating is non-halogenated flame retardant. In these or other embodiments, at most 50%, in other embodiments at most 45%, in other embodiments at most 35%, in other embodiments at most 30%, in other embodiments at most 25%, in other embodiments at most 20%, in other embodiments at most 15% by weight of the dried coating is non-halogenated flame retardant. In one or more embodiments, either coating 24 or 28 includes from about 2% to about 50%, in other embodiments from about 5 to about 40%, and in other embodiments from about 10 to about 30% by weight of the dried coating is non-halogenated flame retardant.

### Preparation of Construction Boards

Generally speaking, the construction boards of the present invention can be prepared by using known techniques that are adapted in view of the teachings of this invention. In general, processes for the manufacture of polyurethane or polyisocyanurate insulation boards are known in the art as described in U.S. Pat. Nos. 6,117,375, 6,044,604, 5,891,563, 5,573,092, U.S. Publication Nos. 2004/01099832003/0082365, 2003/0153656, 2003/0032351, and 2002/0013379, as well as U.S. Ser. Nos. 10/640,895, 10/925,654, and 10/632,343, which are incorporated herein by reference.

As the skilled person appreciates, foam may be produced by developing or forming polyurethane and/or polyisocyanurate foam in the presence of a blowing agent. The foam may be prepared by contacting an A-side stream of reagents with a B-side stream of reagents and depositing the mixture or developing foam onto a laminator carrying a facer. The A-side stream may include an isocyanate compound and the B-side may include an isocyanate-reactive compound. In practicing the present invention, the expandable graphite and optionally the non-halogenated flame retardant are include in one or both of the A-side or B-side stream of reactants. In particular embodiments, both the expandable graphite and the non-halogenated flame retardant are included in the B-side stream.

### A-Side Stream

As suggested above, the A-side stream includes an isocyanate. Suitable isocyanate-containing compounds useful for the manufacture of polyisocyanurate construction board are generally known in the art and embodiments of this invention are not limited by the selection of any particular isocyanate-containing compound. Useful isocyanate-containing compounds include polyisocyanates. Useful polyisocyanates include aromatic polyisocyanates such as diphenyl methane diisocyanate in the form of its 2,4′-, 2,2′-, and 4,4′-isomers and mixtures thereof. The mixtures of diphenyl methane diisocyanates (MDI) and oligomers thereof may be referred to as “crude” or polymeric MDI, and these polyisocyanates may have an isocyanate functionality of greater than 2. Other examples include toluene diisocyanate in the form of its 2,4′ and 2,6′-isomers and mixtures thereof, 1,5-naphthalene diisocyanate, and 1,4′ diisocyanatobenzene. Exemplary polyisocyanate compounds include polymeric Rubinate 1850 (Huntsmen Polyurethanes), polymeric Lupranate M70R (BASF), and polymeric Mondur 489N (Bayer).

### B-Side Stream

As suggested above, the B-side stream includes an isocyanate-reactive compound, and may also include flame retardants, catalysts, emulsifiers/solubilizers, surfactants, blowing agents, fillers, fungicides, anti-static substances, water and other ingredients that are conventional in the art. Also, in accordance with embodiments of this invention, the B-side may include expandable graphite and non-halogenated flame retardant.

An exemplary isocyanate-reactive component is a polyol. The term polyol, or polyol compound, includes diols, polyols, and glycols, which may contain water as generally known in the art. Primary and secondary amines are suitable, as are polyether polyols and polyester polyols. Useful polyester polyols include phthalic anhydride based PS-2352 (Stepen), phthalic anhydride based polyol PS-2412 (Stepen), teraphthalic based polyol 3522 (Invista), and a blended polyol TR 564 (Huntsman). Useful polyether polyols include those based on sucrose, glycerin, and toluene diamine. Examples of glycols include diethylene glycol, dipropylene glycol, and ethylene glycol. Suitable primary and secondary amines include, without limitation, ethylene diamine, and diethanolamine. In one or more embodiments, a polyester polyol is employed. In one or more embodiments, the present invention may be practiced in the appreciable absence of any polyether polyol. In certain embodiments, the ingredients are devoid of polyether polyols.

Catalysts are believed to initiate the polymerization reaction between the isocyanate and the polyol, as well as a trimerization reaction between free isocyanate groups when polyisocyanurate foam is desired. While some catalysts expedite both reactions, two or more catalysts may be employed to achieve both reactions. Useful catalysts include salts of alkali metals and carboxylic acids or phenols, such as, for example potassium octoate; mononuclear or polynuclear Mannich bases of condensable phenols, oxo-compounds, and secondary amines, which are optionally substituted with alkyl groups, aryl groups, or aralkyl groups; tertiary amines, such as pentamethyldiethylene triamine (PMDETA), 2,4,6-tris[(dimethylamino)methyl]phenol, triethyl amine, tributyl amine, N-methyl morpholine, and N-ethyl morpholine; basic nitrogen compounds, such as tetra alkyl ammonium hydroxides, alkali metal hydroxides, alkali metal phenolates, and alkali metal acholates; and organic metal compounds, such as tin(II)-salts of carboxylic acids, tin(IV)-compounds, and organo lead compounds, such as lead naphthenate and lead octoate.

Surfactants, emulsifiers, and/or solubilizers may also be employed in the production of polyurethane and polyisocyanurate foams in order to increase the compatibility of the blowing agents with the isocyanate and polyol components.

Surfactants may serve two purposes. First, they may help to emulsify/solubilize all the components so that they react completely. Second, they may promote cell nucleation and cell stabilization. Exemplary surfactants include silicone copolymers or organic polymers bonded to a silicone polymer. Although surfactants can serve both functions, a more cost effective method to ensure emulsification/solubilization may be to use enough emulsifiers/solubilizers to maintain emulsification/solubilization and a minimal amount of the surfactant to obtain good cell nucleation and cell stabilization. Examples of surfactants include Pelron surfactant 9920, Goldschmidt surfactant 58522, and GE 6912. U.S. Pat. Nos. 5,686,499 and 5,837,742 are incorporated herein by reference to show various useful surfactants.

Suitable emulsifiers/solubilizers include DABCO Ketene 20AS (Air Products), and Tergitol NP-9 (nonylphenol+9 moles ethylene oxide).

Useful blowing agents include isopentane, n-pentane, cyclopentane, alkanes, (cyclo)alkanes, hydrofluorocarbons, hydrochlorofluorocarbons, fluorocarbons, fluorinated ethers, alkenes, alkynes, carbon dioxide, hydrofluoroolefins (HFOs) and noble gases.

### Foam Production

The respective streams can be mixed within, for example, a mixhead to produce a reaction mixture. The mixture can then be deposited onto a facer that is positioned within and carried by a laminator. While in laminator, the reaction mixture rises and can be married to a second facer to form a composite, which may also be referred to as a laminate, wherein the foam is sandwiched between upper and lower facers. The composite, while in laminator, or after removal from laminator, is exposed to heat that may be supplied by, for example, oven. For example, laminator may include an oven or hot air source that heats the slats and side plates of the laminator and there through transfers heat to the laminate (i.e. to the reaction mixture). Once subjected to this heat, the foam composite can undergo conventional finishing within a finishing station, which may include, but is not limited to, trimming and cutting.

According to practice of this invention, the foam mixture is deposited onto a facer that includes a coating layer that includes expandable graphite and optionally non-halogenated flame retardant. As indicated above, the coating (including expandable graphite) is applied to one planar surface of a facer substrate, and the foam mixture is deposited onto the opposite planar surface of the facer substrate (i.e. the surface that does not include expandable graphite). Likewise, the second facer that is married to the rising foam can likewise include a coating including expandable graphite and optionally non-halogenated flame retardant, and the second facer is married to the rising foam opposite the coating.

### INDUSTRIAL APPLICABILITY

In one or more embodiments, the construction boards of this invention may be employed in roofing or wall applications. In particular embodiments, the construction boards are used in flat or low-slope roofing system.

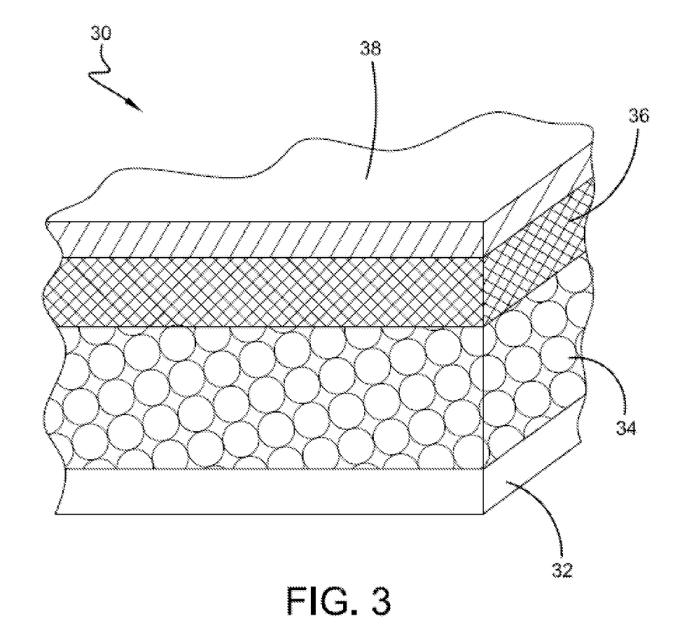

As shown in FIG. 3, roofing system 30 includes a roof deck 32 having insulation board 34, which may be fabricated according to practice of this invention, disposed thereon. An optional high density board 36, which may also be fabricated according to practice of this invention, positioned above, relative to the roof deck, insulation board 34. A water-protective layer or membrane 38 is disposed on top or above high density board 36. In alternate embodiments, not shown, optional high density board 36 may be below insulation board 34 relative to the roof deck.

Practice of this invention is not limited by the selection of any particular roof deck. Accordingly, the roofing systems of this invention can include a variety of roof decks. Exemplary roof decks include concrete pads, steel decks, wood beams, and foamed concrete decks.

Practice of this invention is likewise not limited by the selection of any water-protective layer or membrane. As is known in the art, several membranes can be employed to protect the roofing system from environmental exposure, particularly environmental moisture in the form of rain or snow. Useful protective membranes include polymeric membranes. Useful polymeric membranes include both thermoplastic and thermoset materials. For example, and as is known in the art, membrane prepared from poly(ethylene-co-propylene-co-diene) terpolymer rubber or poly(ethylene-co-propylene) copolymer rubber can be used. Roofing membranes made from these materials are well known in the art as described in U.S. Pat. Nos. 6,632,509, 6,615,892, 5,700,538, 5,703,154, 5,804,661, 5,854,327, 5,093,206, and 5,468,550, which are incorporated herein by reference. Other useful polymeric membranes include those made from various thermoplastic polymers or polymer composites. For example, thermoplastic olefin (i.e. TPO), thermoplastic vulcanizate (i.e. TPV), or polyvinylchloride (PVC) materials can be used. The use of these materials for roofing membranes is known in the art as described in U.S. Pat. Nos. 6,502,360, 6,743,864, 6,543,199, 5,725,711, 5,516,829, 5,512,118, and 5,486,249, which are incorporated herein by reference. In one or more embodiments, the membranes include those defined by ASTM D4637-03 and/or ASTM D6878-03.

Still in other embodiments, the protective membrane can include bituminous or asphalt membranes. In one embodiment, these asphalt membranes derive from asphalt sheeting that is applied to the roof. These asphalt roofing membranes are known in the art as described in U.S. Pat. Nos. 6,579,921, 6,110,846, and 6,764,733, which are incorporated herein by reference. In other embodiments, the protective membrane can derive from the application of hot asphalt to the roof.

Other layers or elements of the roofing systems are not excluded by the practice of this invention. For example, and as is known in the art, another layer of material can be applied on top of the protective membrane. Often these materials are applied to protect the protective membranes from exposure to electromagnetic radiation, particularly that radiation in the form of UV light. In certain instances, ballast material is applied over the protective membrane. In many instances, this ballast material simply includes aggregate in the form of rock, stone, or gravel; U.S. Pat. No. 6,487,830, is incorporated herein in this regard.

The construction boards of this invention can be secured to a building structure by using various known techniques. For example, in one or more embodiments, the construction boards can be mechanically fastened to the building structure (e.g. the roof deck). In other embodiments, the construction boards can be adhesively secured to the building structure.

Various modifications and alterations that do not depart from the scope and spirit of this invention will become apparent to those skilled in the art. This invention is not to be duly limited to the illustrative embodiments set forth herein.

1. A construction board comprising:
a foam layer; and
at least one facer, wherein the at least one facer includes a substrate and a coating, wherein said facer includes a first planar surface and a second planar surface, and where said first planar surface is in contact with said foam layer and where said coating is disposed on said second planar surface, where the coating includes expandable graphite.

2. The construction board of claim 1, wherein the foam layer includes expandable graphite.

3. The construction board of claim 1, wherein the foam layer includes from about 2% to from about 50% expandable graphite based upon the density of the foam.

4. The construction board of claim 1, wherein the substrate is a glass mat.

5. The construction board of claim 4, wherein the substrate is cellulosic.

6. The construction board of claim 4, wherein the coating is applied to the facer in a crisscross or an irregular manner.

7. The construction board of claim 1, wherein said foam layer includes a non-halogenated flame retardant.

8. The construction board of claim 1, wherein said coating includes a non-halogenated flame retardant.
